(19) United States
(12) Patent Application Publication
(10) Pub. No.: US 2022/0081251 A1
(43) Pub. Date: Mar. 17, 2022

(54) Retaining System

(71) Applicants: Ricky Don CARTER, Alba, TX (US); Marjorie Daphne CARTER, Alba, TX (US)

(72) Inventors: Ricky Don CARTER, Alba, TX (US); Marjorie Daphne CARTER, Alba, TX (US)

(21) Appl. No.: 17/478,072

(22) Filed: Sep. 17, 2021

Related U.S. Application Data
(60) Provisional application No. 63/079,854, filed on Sep. 17, 2020.

(51) Int. Cl. B65H 81/06; A01K 97/00

(52) U.S. Cl. CPC B65H 81/06; B65H 2701/355; A01K 97/00

(57) ABSTRACT

A retaining system for enclosing the free end of a line. The system has a retaining band with an inner side and an outer side. Coupled to the retaining band is a multiple length clasp. The inner side can have a clasp and the outer side can have a clasp. When the retaining band is wrapped around a spool, the retaining band couples with itself. In so doing, the retaining band keeps the free end of a line from undesirably unraveling.

### PRIORITY

The present invention claims priority to provisional application No. 63/079,854 filed Sep. 17, 2020, the entirety of which is hereby incorporated by reference.

### BACKGROUND OF THE INVENTION

### Technical Field

The present invention relates to a system and method for a retaining band.

### Description of Related Art

Thread, fishing line, rope, wire, etc. is often placed upon a spool. However, the spool can undesirably unwind. Consequently, there is a need for a system which can retain the spool's contents.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a closed retaining band in one embodiment;

FIG. 2 is a perspective view of a partially unwrapped retaining band in one embodiment;

FIG. 3 is a perspective of a partially unwrapped retaining band in one embodiment;

FIG. 4 is a perspective of a completely unwrapped retaining band in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

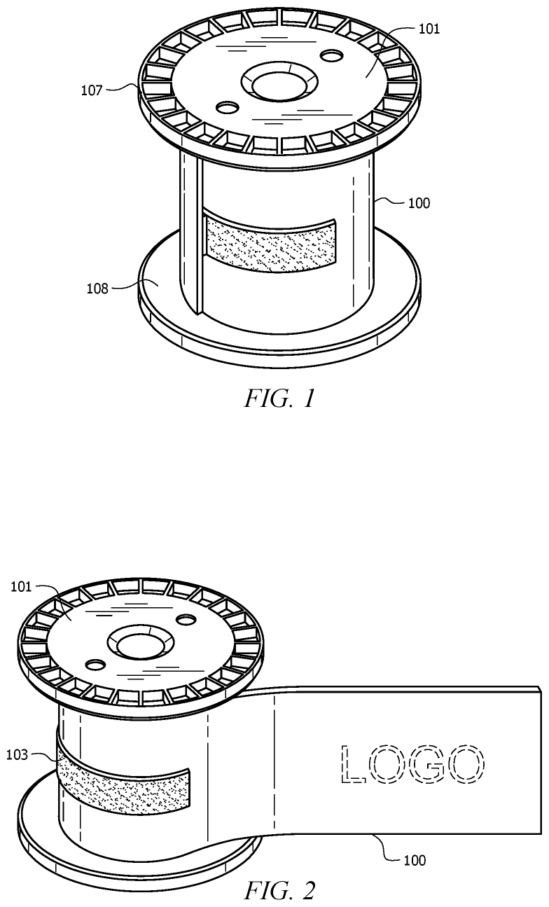

FIG. 1 is a perspective view of a closed retaining band in one embodiment. The retaining band 100 is shown wrapped around and in a closed position. The closed position is a position wherein the retaining band 100 retains the line on the spool 101.

A spool 101, as used herein, refers to a device upon which a line can be wrapped and stored. Often the spool 100 will have a spool top 107 and a spool bottom 108 which are connected by a vertical cylinder. A line can be wrapped around the vertical cylinder.

There are a variety of types and sizes of spools. The spools can be large or small. For example, a spool 101 can be a thread spool onto which thread is wrapped. In other embodiments the spools can be large such that the spool top 107 resembles a table-top. Such spools 101 can be used to hold wound wire. The term “line” as used herein, refers to any item which can be wound and stored on a spool 101. The line can include thread, wire, chords, tape, rope, etc. Virtually any elongated material which can be wrapped around a spool can be used. In one embodiment the line comprises fishing line. An embodiment wherein the line comprises fishing line is described below herein. While a fishing line is disclosed this is for illustrative purposes only and should not be deemed limiting.

In one embodiment the line has a fixed end and a free end. The fixed end is not free to move. In some embodiments the fixed end is physically coupled to the spool 101 such that it cannot move. It can be fixed via adhesive, tape, a physical knot and wedge, etc. In other embodiments, the fixed end is not physically fixed but is fixed because it is under the weight and pressure of other line which is wrapped around the fixed end such that the fixed end cannot move. This is similar to lashing whereby a lower level of line is kept in place by an outer layer of line.

The free end of the line, unlike the fixed end, is free to move. The user can pull a desired amount of line and cut it or otherwise remove it from the line remaining on the spool 101. Unfortunately, the free end, because it is free to move, often unravels. Because the line is wrapped and typically only stays in a wrapped orientation due to friction of the tightly wound line, when the free end becomes unwound, a large amount of line can become unwound from the spool 101. The user then has to rewind the line onto the spool 101. This takes time, energy, and patience. Further, when large lengths of line become unwound, knots and tangles can result. Accordingly, in one embodiment a retaining band 100 is utilized.

A retaining band 100 is a binding which holds the free end of the line and prevents the line from undesirably unwinding. The retaining band 100 locks the free end in place and can maintain pressure on the line to prevent unwinding.

In one embodiment the system further comprises a catch. A catch, as used herein, refers to a device which catches and holds the free end. The catch can be located on the spool, or it can be located on the retaining band. The catch can comprise a notch in the spool, as an example. In use, the user takes the free end and couples the free end to the catch. This secures the free end so the user can easily find and grasp the free end. The catch can comprise a hole through which the free end is inserted. Thus, the user can place the free end through a hole on the spool, spool top, spool bottom, etc. such that the free end is easily found by the user. In one embodiment the user threads the free end through a hole in retaining band so that the free end is readily found. In one embodiment the retaining band comprises a housing through which the free end is inserted making it easier to locate the free end once the retaining band 100 is removed.

The retaining band 100 can comprise virtually any pliable material. It can comprise leather, plastic, rubber, neoprene, cloth, and combinations thereof. The retaining band 100 is bendable so as to be wound and bend around the spool 101.

As depicted the retaining band 100 has a length and a height. As depicted in FIGS. 1 and 2, the length of the retaining band 100 is parallel with the plane of the spool top 107. The length of the retaining band 100 can vary depending upon the application. In one embodiment the length is sufficiently long to wrap around the wound line. In one embodiment the length of the retaining band 100 is greater than the circumference of the spool top 107. This ensures that the retaining band 100 will have sufficient length to wrap around a line retained on the spool, assuming the wrapped line does not exceed the diameter of the spool top 107.

The height of the retaining band 100, in one embodiment, is less than the distance between the spool top 107 and the spool bottom 108. In one embodiment the height of the retaining band 100 is approximately the same as the distance between the spool top 107 and the spool bottom 108. This ensures that regardless of the location of the free end along the height of the spool 101, the retaining band 100 will capture the free end. In other embodiments, however, the height does not extend for the entire height of the spool 101. Instead, the retaining band 100 is placed to align with the location of the free end.

FIG. 2 is a perspective view of a partially unwrapped retaining band in one embodiment. In this embodiment the left side of the retaining band 100 is placed adjacent the line in the spool 101. The retaining band 100 is wrapped around such that the left side of the retaining band 100 couples to the right side of the retaining band.

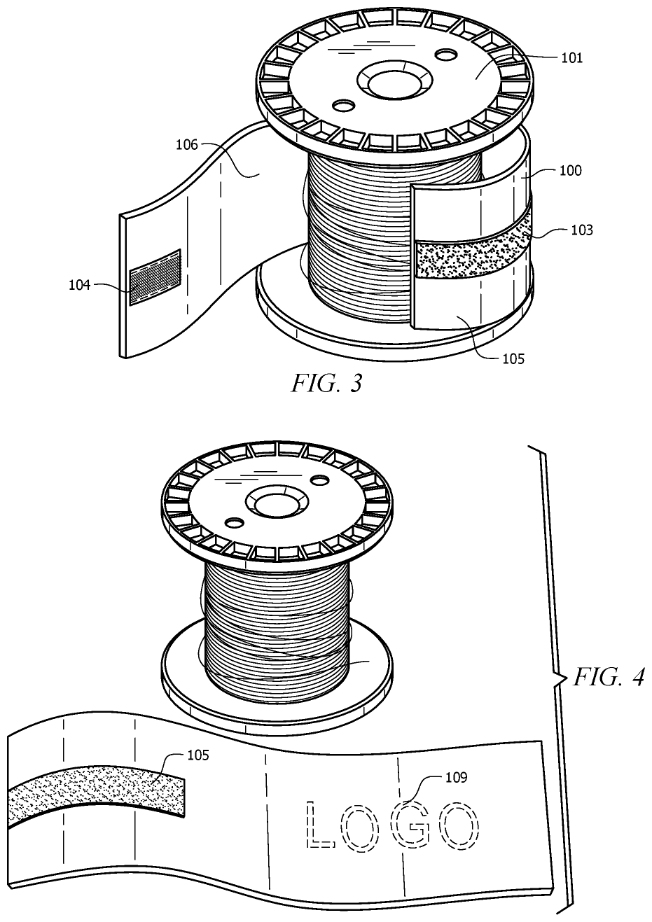

FIG. 3 is a perspective of a partially unwrapped retaining band in one embodiment. As can be seen, in this figure the retaining band 100 has one clasp on the inner layer 106 and one clasp on the outer layer 105. A clasp refers to a coupling or attaching device which secures one end of the retaining band 100 to the other. As shown, the clasp comprises a hook and loop system such as Velcro, but this is for illustrative purposes and should not be deemed limiting. In other embodiments, the system can comprise straps, zippers, buttons, etc. Virtually any mechanism which allows one end of a strap to be attached to another end can be utilized.

As noted, FIG. 3 depicts an embodiment wherein the strap utilizes Velcro. The inner side 106 has a vertical clasp 104 whereas the outer strap has a horizontal clasp 103. In other embodiments, this arrangement can be flipped with the horizontal clasp 103 on the inner side 106. This type of arrangement is referred to as a multiple length clasp because it allows the effective length of the retaining band 100 to be adjusted. Put differently, a multiple length clasp allows for the diameter formed from the coupled retaining band 100 to be adjusted.

The arrangement discussed above with as horizontal clasp 103 and a vertical clasp 104 has the benefit in that the length can be adjusted depending on the outside diameter of the wrapped line. When the spool 101 is initially full and the left side can engage with the right side closer to the end of the right side. When the spool 101 has been depleted such that the diameter of the wrapped line is decreased, the left side can engage the right side at a location further from the edge. This results in an effectively shorter retaining band 100. Thus, a multiple length clasp provides for the diameter formed from the coupled retaining band 100 to be adjusted. It can be a larger diameter when the spool 101 is full of line but progressively smaller when the line has been used.

There are multiple types of multiple length clasps. As noted, hook and loop is but one example. Other adjustable straps which allow the length of the retaining band 100 to be adjusted can be used as well. This can include the various clasps described above. The clasp, as noted, can comprise any method or device which allows the retaining band 100 to secure against itself. It can include zippers, buttons, snaps, etc. As on example, the inner layer 106 comprises a button and the outer layer 105 comprises a plurality of snaps which mate with the button spread along its length. In another embodiment the inner layer 106 comprises a hook which can mate with a corresponding hook on the outer layer 106. In one such embodiment a plurality of such hooks are spaced along the length of the outer layer 105. Similarly, one end of the band 100 can comprise magnets with the other end either comprising metal or magnets. As shown, there are a variety of clasps which allow the retaining band 100 to secure itself along the spool.

FIG. 4 is a perspective of a completely unwrapped retaining band in one embodiment. As can be seen, the outer side 105, in this embodiment, has the horizontal clasp 103. This allows the vertical clasp 104 to be coupled to the horizontal clasp 103 at the appropriate location to ensure a tight and snug fit against the free end of the line. This snug fit prevents the free end from undesirably unwinding.

FIG. 4 also shows text 109 on the outer side 105. The text 109 can be used to identify the spool, line, etc. As an example, there are different types of fishing lines. An angler can have multiple different lines depending upon what they are fishing. The text 109 can identify the line so the angler can quickly and easily select the desired line. In one embodiment the retaining band 100 further comprises a handle which allows the user to handle the retaining band 100, and accordingly, the covered spool 101.

To use the retaining band, the user finds a spool they desire to secure. The free end can be left free, or it can be coupled to a catch located on either the spool or the retaining band. In other embodiments the free end is placed under wound line in a lashing to keep it in the desired location. Thereafter, one end of the retaining band 100 is placed adjacent the spool. In one embodiment the retaining band 100 is placed between the spool top 107 and the spool bottom 108. Securing the first end of the retaining band 100, the retaining band 100 is wrapped around the spool. Once tightly wrapped around the spool 101, the second end is secured to the first end via a clasp. As noted, in one embodiment the clasp is integrated into the retaining band 100, as shown in the figures. Once secured, the bounded spool can be placed in any location. The retaining band 100 will prevent the free end from undesirably unwinding. Multiple bound spools can be placed and stored atop one another.

The retaining band discussed herein offers many advantages. First, the retaining band prevents the line from undesirably unwinding which can result in an unwieldy length of line. As noted, the unwound line can result in knots, tangles, etc. The retaining band 100, by fitting snuggly against the line and the free end of the line, ensures there is tension applied to prevent the free end from unwinding. Even if the spool 101 were to tip over, it would not unwind. This is particularly helpful if the spool 101 is kept on a boat, for example.

Another advantage is the ability to identify the contents. This is helpful for identifying fishing line test, thread size, wire gauge, etc. The text 109 can help identify the type of the line, such as fishing line.

While the invention has been particularly shown and described with reference to a preferred embodiment, it will be understood by those skilled in the art that various changes in form and detail may be made therein without departing from the spirit and scope of the invention.

What is claimed is:

1. A system for retaining comprising:
a retaining band with an inner side and an outer side;
a multiple length clasp coupled to said retaining band.

2. The system of claim 1 wherein said inner side comprises a clasp, and wherein said outer side comprises a clasp.

3. The system of claim 2 wherein said clasp of said inner clasp comprises a hook and loop system, and wherein said clasp of said outer side comprises a hook and loop system.

4. The system of claim 3 wherein said clasp of said outer side is a horizontal clasp, and wherein said clasp of said inner side is a vertical clasp.

5. The system of claim 1 further comprising a spool, and wherein said spool comprises a line.

6. The system of claim 5 wherein said spool comprises a spool top and a spool bottom, and wherein said spool top comprises a circumference.

7. The system of claim 6 said retaining band comprises a length, and wherein the length of the retaining band is greater than the circumference of said spool top.

8. The system of claim 6 wherein said spool top and said spool bottom are coupled via a vertical cylinder.

9. The system of claim 6 wherein said spool top and spool bottom are separated by a spool distance, and wherein said retaining band comprises a height, and wherein the height of the retaining band is approximately the same as the spool distance.

10. The system of claim 5 wherein said line comprises a fixed end a free end.

11. The system of claim 10 wherein said free end couples to a catch.

12. The system of claim 11 wherein the catch is located on the spool.

13. The system of claim 11 wherein the catch is located on said retaining band.

14. The system of claim 1 wherein said retaining band comprises text.

15. The system of claim 14 wherein said text identifies the type of line.

16. The system of claim 15 wherein said line comprises fishing line.

17. The system of claim 1 wherein said retaining band comprises a handle.
